(19) United States
(12) Patent Application Publication
(10) Pub. No.: US 2025/0037079 A1
(43) Pub. Date: Jan. 30, 2025

(54) STRUCTURED REPRESENTATIONS WITH TEMPORAL RELEVANCE LEVELS FOR DATA FIELDS

(71) Applicant: Caterpillar Inc., Peoria, IL (US)

(72) Inventors: Naseer Ahmed Niaz, Peterborough (GB); Sorin Calugar, Peoria, IL (US)

(73) Assignee: Caterpillar Inc., Peoria, IL (US)

(21) Appl. No.: 18/360,644

(22) Filed: Jul. 27, 2023

(51) Int. Cl. G06Q 10/10

(52) U.S. Cl. CPC G06Q 10/103

(57) ABSTRACT

This disclosure provides techniques for assessing projects based on their project fields and evaluating their progress. In accordance with the techniques described herein, an example system may use project schemas that include various project fields, such as precondition, success criterion, in-scope, and out-of-scope fields, to define requirements-related concepts associated with the projects. These project fields may be characterized by their relevance levels, maturity levels, and description data. The system employs assessment measures that consider the relevance level and maturity level of the project fields to determine the project's assessment report.

### TECHNICAL FIELD

The present disclosure relates to data analysis applications, and more particularly to using structured schemas to enhance data analysis efficiency and accuracy.

### BACKGROUND

In conventional project management systems, assessment and evaluation of projects are performed based on various parameters such as scope, resources, schedule, and cost. The project information is typically stored in a disorganized and inconsistent manner, often across various documents, spreadsheets, or databases. This often leads to inefficient data processing, making it difficult to accurately assess project readiness and progress. Furthermore, understanding dependencies between different projects or tasks, identifying similarities between projects, and generating comprehensive project reports are time-consuming and error prone. The complexity increases even further when trying to handle large, multi-faceted projects with many interdependent tasks, such as on industrial worksites involving loading machines, hauling machines, transport machines, etc.

An example of a proposed solution to the problems described above is US Patent Application Publication No. 20220237565, entitled “System and Method for Project Accountability Services.” The '565 publication discloses a project schema that includes “project member information comprising at least one of a name, a title, a role, an employee status, an organization, an email address, a phone number, a supervisor name, and a contribution.” The '565 publication discloses using the project member information to generate a project member hash record for the corresponding project.

However, the solution disclosed in the '565 publication has several limitations. For instance, while the solution provides for some level of structured representation of project member information, it does not use a structured data representation to define the requirements-related concepts of the projects. Furthermore, solution disclosed in the '565 publication does not address the need for determining project dependencies or measuring similarities between projects. Such a lack of specialized engines to perform these tasks restricts the ability to efficiently process complex data and provide valuable insights, especially in a large-scale, multi-project industrial setting.

### SUMMARY

In some aspects, the techniques described herein relate to a computer-implemented method, including retrieving a first project schema comprising a first project field associated with a first project, and determining a first relevance level indicated by the first project field. In such examples, the first relevance level represents a respective readiness level from a plurality of readiness levels at which a first requirement corresponding to the first relevance level is triggered. Example techniques also include determining a first maturity level associated with the first project field. In such examples, the first maturity level represents a measure of confidence in definitional maturity of the first requirement. Example techniques further include selecting a current readiness level from the plurality of readiness levels, wherein the current readiness level represents an estimated maturity of the first project. Such example techniques also include determining a readiness value based on whether the first relevance level satisfies a triggering condition represented by the current readiness level, determining a maturity value based on whether the first maturity level satisfies a maturity condition, and determining an assessment measure associated with the first project field based on the readiness value and the maturity value. Such example techniques further include providing the assessment measure using an assessment platform.

In additional examples, the techniques described herein relate to a computing system, including: a processor; and memory storing computer-executable instructions that, when executed by the processor, cause the computing system to perform operations including receiving, as an input of the computing system, a first project schema comprising a first project field associated with a first project. In such examples, the first project field is associated with a first relevance level, the first relevance level represents a respective readiness level from a plurality of readiness levels at which a first requirement corresponding to the first relevance level is triggered; the first project field is associated with a first maturity level, and the first maturity level represents a measure of confidence in definitional maturity of the first requirement. Example techniques further include operations including receiving a current readiness level from the plurality of readiness levels. In such examples, the current readiness level represents an estimated maturity of the first project. Example techniques further include operations including providing the first project field and the current readiness level to a readiness determination subsystem and receiving, from the readiness determination subsystem, a readiness value based on whether the first relevance level satisfies a triggering condition represented by the current readiness level. Example techniques further include operations including providing the first project field to a maturity determination subsystem and receiving, from the maturity determination subsystem, a maturity value based on whether the first maturity level satisfies a maturity condition. Example techniques further include operations including determining, as an output of the computing system, a recommended value for an operational parameter of a project system associated with the first project schema based on the readiness value and the maturity value. Example systems further include transmitting the recommended value to the project system.

In further examples, the techniques described herein relate to one or more non-transitory computer-readable media storing computer-executable instructions that, when executed by the processor, cause the one or more processors to perform operations, including transmitting a first project schema comprising a first project field associated with a first project to a computing system. In such examples, the first project field is associated with a first relevance level, the first relevance level represents a respective readiness level from a plurality of readiness levels at which a first requirement corresponding to the first relevance level is triggered, the first project field is associated with a first maturity level, and the first maturity level represents a measure of confidence in definitional maturity of the first requirement. Example techniques further include operations including transmitting a current readiness level from the plurality of readiness levels to the computing system. In such examples, the current readiness level represents an estimated maturity of the first project. Example techniques further include operations including receiving, from the computing system, a recommended value for an operational parameter of a hardware device. In such examples, the computing system determines the recommended value based on a readiness value and a maturity value, the readiness value is determined based on whether the first relevance level satisfies a triggering condition represented by the current readiness level, and the maturity value based on whether the first maturity level satisfies a maturity condition. Example techniques further include modifying the operational parameter of the hardware device based on the recommended value.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 provides an example architecture for structured project reporting.

FIG. 2 is a flowchart diagram of an example process for assessing a project with respect to a project field.

FIG. 3 is a flowchart diagram of an example process for determining a field-wise similarity measure between a first field of a first project and a second field of a second project.

FIG. 4 is a flowchart diagram of an example process for determining whether a first project is operationally dependent on a second project.

FIG. 5 is an operational example of an operational domain with three projects.

FIG. 6 provides an example assessment user interface that allows a user to input information for a set of project fields.

FIG. 7 is a flowchart diagram of an example process for providing a project report for a first project.

FIG. 8 shows an example system architecture for a computing device associated with the architecture described herein.

### DETAILED DESCRIPTION

This disclosure provides techniques for assessing projects based on their project fields and evaluating their progress. In accordance with the techniques described herein, an example system uses project schemas that include various project fields, such as precondition, success criterion, in-scope, and out-of-scope fields, to define requirements-related concepts associated with the projects. These project fields is characterized by their relevance levels, maturity levels, and description data. The system employs assessment measures that consider the relevance level and maturity level of the project fields to determine the project's assessment report. In accordance with the techniques described herein, project schemas can be used by a dependency engine, similarity engine, and reporting engine that leverage the project schemas to perform specialized operations. The dependency engine determines project dependencies based on explicit user-defined relationships or inferred relationships between requirements of different projects. The similarity engine may compute the similarity between projects based on the similarity between their project schemas, for example by utilizing natural language processing (NLP) models to determine textual description data associated with the data fields. The reporting engine utilizes the project schema to generate reports, which can be provided to worksite planners or other users to aid in project coordination and decision-making.

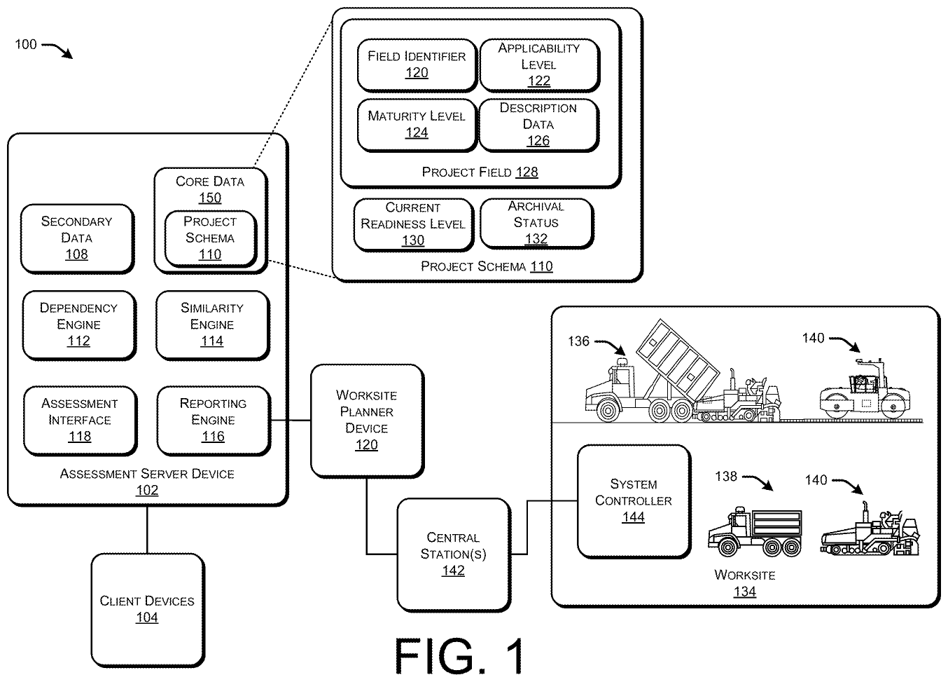

FIG. 1 provides an example environment 100 for structured project reporting. As depicted in FIG. 1, the environment 100 includes a client device 104, an assessment server device 102, and a worksite planner device 120. The client device 104 serves as the interface between the user and the assessment system. The client device 104 enables the user to input and provide data related to a project by interacting with an assessment user interface 118 provided by the assessment server device 102. The data transmitted from the client device 104 to the assessment server device 102 includes at least one of a project schema 110 or secondary data 108.

The project schema 110 includes a set of data values describing a current state of a project that are provided using a predefined data reporting format. For example, project schema 110 includes a set of data values describing project requirements, specifications, milestones, resources, or any other relevant information necessary for the assessment. The project schema 110 is a structured representation of a current and future state of the project, enabling the assessment server device 102 to understand and analyze its components accurately. The project schemas 110 may be stored as part of core data 150 of the assessment server device 102.

The project schema 110 represents a set of requirements defined for the project, for example a set of performance requirements and/or a set of completion requirements for the project. The project schema 110 includes various components, including a set of project fields 128. These project fields 128 describes values describing quality requirements or completion requirements associated with the project's assessment. Each project field 128 represents a specific concept related to the project requirements that becomes applicable or triggered as the project reaches a particular level of readiness. In other words, the project fields 128 serves as indicators of the project's progress and readiness for specific milestones or goals.

Each project field 128 associated with a project describes a unique requirements-related concept, providing specific information about the project. However, different project fields convey different types of requirements-related information, serving distinct purposes within the assessment and planning process. For example, a precondition project field describes a condition that is required to be met before the project can commence or progress and/or to ensure the project's smooth execution, such as the need for necessary permits and licenses, the completion of a feasibility study, or the acquisition of required funding or resources. A success criterion project field describes a criterion that is required to be satisfied for the project to be considered successful or complete. A success criterion project field describes one or more goals, objectives, and/or performance standards the project aims to achieve. Examples of success criterion project fields include fields describing reaching a specific sales target, delivering the final product within the agreed timeline, or maintaining a customer satisfaction rating above a certain threshold. An in-scope project field describes a subject matter that is within the project scope, such as deliverables, features, and/or functionalities that the project is required to deliver. Examples of in-scope project fields include development of core software modules, the integration of third-party application programming interfaces (APIs), or the design and implementation of user interfaces. An out-of-scope project field describes a subject matter explicitly excluded from the project's scope. Accordingly, out-of-scope project fields defines boundaries and clarify what will not be addressed within the project. Examples of out-of-scope project fields includes fields describing the integration with legacy systems not part of a project, the design or modification of physical infrastructure, or the training and onboarding of end-users. In some cases, by utilizing these different types of project fields 128, the project schema 110 captures and communicates various requirements-related information, enabling effective project assessment, planning, and management while ensuring that all relevant aspects are considered and addressed.

Each project field 128 is associated with a field unique identifier (e.g., a field identifier that is unique across all of the project fields 128 associated with the same project) and a relevance level 122. The relevance level 122 represents the point at which the requirements-related concepts associated with the project field 128 becomes most relevant or critical. The relevance level 122 describes when the requirement transitions from being optional to becoming a necessary condition for project completion. The relevance level 122 enables the system to determine the timing and significance of each project field 128, ensuring that the appropriate requirements are met at the right stage of the project.

The relevance level 122 associated with a project field 128 describes a readiness level, such as a technology readiness level (TRL), at which the requirements-related concept linked to the project field 128 becomes most relevant or triggered/activated. For example, a project may have a project field representing a precondition that must be fulfilled before the project can proceed. The associated relevance level indicates that this precondition becomes most relevant or triggered when the project reaches a specific technology readiness level (TRL), such as TRL 3, which signifies the completion of initial proof-of-concept activities. As another example, a success criterion project field may have a relevance level indicating that the success criteria become activated at a particular readiness level, such as TRL 7, when the project has advanced through research, design, and development, and is ready for validation and demonstration in a relevant environment. As a further example, an in-scope project field could have a relevance level that signifies that the field may become most relevant when the project reaches TRL 4 by completing all proof-of-concept stages. As an additional example, an out-of-scope project field may have a relevance level denoting that the field becomes activated at TRL 5, after successful completion of inter-component testing for the project.

Each project field 128 within the project schema 110 may have a maturity level 124 that indicates the level of definition and/or clarity of the associated requirements-related concept. The maturity level 124 describes how well-defined and understood the concept is within the context of the project. For example, a first project field may have a high maturity level, indicating a well-defined and extensively documented concept. This high level of maturity is assigned when the concept is thoroughly researched, validated, and supported by industry standards or best practices. For example, a project field specifying compliance with a regulatory standard may have a high maturity level, as it is based on well-established guidelines and requirements. As another example, a second project field may have a lower maturity level, indicating a requirement that is still in the exploration or development stage. This lower level of maturity is assigned when the requirement is based on emerging technologies, evolving industry practices, or ongoing research. As a further example, a project field may have a moderate maturity level, representing a requirement that is partially defined or undergoing refinement. This level of maturity is assigned when the requirement has been identified and documented to a certain extent but may still require further clarification or validation.

The relevance level 122 and the maturity level 124 may signify different aspects of the relevance and significance of a requirements-related concept associated with a project field 128 in assessing the progress and/or state of a project. In some cases, the relevance level 122 and the maturity level 124 may provide complementary data that helps evaluate the relevance and maturity of a requirements-related concept within the context of project assessment. The relevance level 122 indicates when a requirements-related concept becomes relevant or triggered during the project lifecycle. The relevance level 122 identifies the specific stages or conditions at which the concept is most pertinent for assessment. For example, consider a project field 128 representing a validation process that ensures compliance with regulatory standards. The relevance level indicates that the validation process becomes relevant when the project reaches a certain milestone, such as the completion of a critical design phase. This information allows project managers to determine when to initiate and assess the validation process based on the project's progress. On the other hand, the maturity level 124 represents the comprehensiveness and/or the reliability of definition of the requirements-related concept. The maturity level 124 indicates how well-defined and/or refined the concept is within the context of project assessment. Continuing with the previous example, the maturity level represents the extent to which the validation process has been documented, tested, and refined. A higher maturity level indicates a well-established and thoroughly validated process, while a lower maturity level indicates ongoing development or exploration. The maturity level helps project teams gauge the reliability and confidence associated with the concept, informing decisions about its implementation and the weight it carries in the assessment of progress. Together, the relevance level 122 and maturity level 124 may provide a comprehensive perspective on the pertinence and readiness of a requirements-related concept for project assessment. By considering both levels, project managers can determine when and how to evaluate and apply the concept effectively.

A project field 128 is associated with description data 126, which provides additional details and/or context about the associated requirements-related concepts. The description data 126 includes text data, including free-form text data that allows for flexible and descriptive representation. For example, the description data 126 for a project field 128 includes a textual description for the project field 128 as provided by the user and/or as automatically determined using a natural language processing model.

The project schema 110 for a project includes a current readiness level 130 (e.g., a TRL) that represents the project's overall readiness and/or maturity at a given point in time. The current readiness level 130 serves as an indicator of the project's progress and development. By comparing the current readiness level 130 with the relevance level 122 of a project field 128, the assessment server device 102 determines when the project field 128 becomes most relevant or activated within the project. In some cases, when the current readiness level 130 aligns with or exceeds the relevance level 122 of a project field 128, this development indicates that the associated requirements-related concept becomes most relevant or triggered. For example, if a project field has a relevance level of TRL 4, and the project's current readiness level is also TRL 4 or higher, it signifies that the project field is activated, and its requirements-related concept is applicable and relevant to the project at that stage. In some cases, by considering the relationship between the current readiness level 130 and the relevance level 122, project managers can identify the appropriate time or stage at which each project field 128 becomes significant for assessing the project's progress. The comparison allows for a dynamic and context-aware evaluation of the project, ensuring that the right project fields are considered and applied as the project reaches the corresponding level of maturity. This approach facilitates effective decision-making and helps ensure that the project's requirements are appropriately addressed throughout its lifecycle.

The project schema 110 for a project includes an archival status designator 132, which provides information about whether the project has been archived. The archival status designator 132 serves as an indicator of the project's archival state, indicating whether it remains active and ongoing. A project is automatically archived by the assessment server device 102 when one or more archiving conditions are satisfied. These archiving conditions is defined based on various factors that indicate whether a project is still active. Examples of such factors include the duration since the project's creation, the time elapsed since the project was last updated, the duration since the project reached the execution stage, the length of time since the last action was performed in relation to the project, and the specific stage of the project. In some cases, the archiving conditions are defined in such a way that a project in an earlier stage, such as the ideation stage, is eligible for archiving sooner compared to a project in a later stage, such as the execution stage. This approach recognizes that projects in different stages may have varying levels of activity, completion, or relevance, and therefore have different archiving priorities.

The project schemas 110 for projects is used to support different processing operations performed by various components of the assessment server device 102. These components utilizes the project schemas 110 to extract meaningful insights and generate valuable outputs related to project analysis. Examples of project-related processing operations that uses project schemas 110 include dependency determination operations performed by the dependency engine 112, similarity determination operations performed by the similarity engine 114, and reporting operations performed by the reporting engine 116.

The dependency engine 112 uses the project schemas 110 to identify and establish project dependencies. By analyzing the relationships and relevant factors within the schemas, the dependency engine 112 determines the operational connections and interdependencies between different projects. These determinations may then be used by the assessment server device 102 to enable planning, resource allocation, and decision-making processes.

The dependency engine 112 is configured to determine and/or manage dependencies between projects. These dependencies can be explicitly defined by the user or inferred based on the relationships between requirements of different projects. By analyzing the project data, the dependency engine 112 identifies interdependencies between pairs and establishes the operational relationships between projects. For example, if the success criterion of a first project serves as a precondition for the execution of another project, the dependency engine 112 determines that the second project is operationally dependent on the first project. By recognizing such relationships, the dependency engine 112 may establish a logical flow and sequence of projects, ensuring that the projects are executed in the appropriate order and that the necessary dependencies are fulfilled. The dependency engine 112 enables the assessment server device 102 to understand the operational connections between different projects, optimizing resource allocation and enhancing project planning and execution.

For example, if a Project A involves the development of a software module that provides a crucial functionality required by a Project B, the dependency engine 112 determines that Project B is operationally dependent on Project A, as Project B cannot proceed without the completion and availability of the software module developed in Project A. As another example, if a Project C focuses on the construction of a physical infrastructure, such as a building or facility, which serves as a prerequisite for a Project D, the dependency engine 112 determines that Project D, which could involve the installation of equipment or systems within the constructed facility, is operationally dependent on the successful completion of Project C. As a further example, if a Project E aims to design and manufacture a component that is essential for the assembly of a larger system in Project F, the dependency engine 112 determines that Project F is operationally dependent on Project E, as the completion of Project E is a critical requirement for Project F and the component produced in Project E is integral to the functioning of the overall system in Project F.

In some cases, the dependency engine 112 utilizes the project schemas 110 of two projects to assess and determine the dependency between them. For example, consider two projects, Project A and Project B, with their respective project schemas. Project A has a project field indicating that it requires the completion of a specific software module developed in Project B. The dependency engine 112 can examine the project schemas 110 and identify the dependency between these two projects by analyzing the relevant fields and their associated data. By recognizing the dependency between Project A and Project B, the dependency engine 112 can provide valuable insights and information. For example, the dependency engine 112 can highlight that Project A relies on the successful completion of the software module developed in Project B. This dependency information may assist project managers in coordinating the timing, sequencing, and resource allocation between the two projects to ensure smooth execution and avoid potential bottlenecks or delays.

The similarity engine 114 relies on the project schemas 110 to determine the similarity between projects. The similarity engine 114 can processes the data within the project schemas 110 (e.g., project fields) to determine similarity measures. These measures can enable the identification of commonalities, shared characteristics, and patterns across projects, facilitating knowledge sharing and best practice identification.

The similarity engine 114 is configured to determine a degree of similarity between two projects based on the similarities observed within their project schemas. By comparing the project schemas of two projects, the similarity engine 114 can determine a similarity measure that quantifies the level of resemblance or overlap between the projects. This measure can enable the assessment server device 102 to assess the similarity between different projects and identify commonalities or shared characteristics. In some cases, to determine the similarity measure, the similarity engine 114 leverages the relevant fields (e.g., project fields) within the project schemas of the two projects. For example, if the first project has X relevant fields, and the second project has Y relevant fields, the similarity engine 114 may combine X*Y similarity values, where each similarity value represents the comparison between a field of the first project and a field of the second project. To compare two fields, the similarity engine 114 may provide description data 126 associated with the two fields to an NLP model that is configured to determine a measure of similarity of two text inputs.

In some cases, the similarity engine 114 performs comparisons between fields of two projects only when those fields share the same readiness category. For example, the similarity engine 114 may compare two success criterion project fields with each other to determine a similarity value, but it may skip comparing a success criterion project field with an out-of-scope project field. This approach may ensure that meaningful comparisons are made between relevant fields while avoiding unnecessary or unrelated comparisons. By focusing on fields within the same readiness category, the similarity engine 114 can extract meaningful insights regarding similarities, patterns, or shared characteristics that are pertinent to that specific category. For example, comparing two success criterion project fields allows for the identification of similarities in the goals, objectives, and/or performance standards set for different projects. On the other hand, comparing a success criterion project field with an out-of-scope project field may not yield meaningful or informative results, as these fields represent different aspects of the project.

The reporting engine 116 uses the project schemas 110 to generate comprehensive assessment reports. By extracting data from the project schemas 110, including project fields, assessment results, and other relevant information, the reporting engine 116 can generate assessment reports that evaluate progress, compliance with requirements, and performance against predefined metrics. These assessment reports can support decision-making, highlight areas for improvement, and aid in project management activities. In some cases, to determine an assessment report associated with the project, the reporting engine 116 uses the project schema 110 and the secondary data 108 associated with the project.

The secondary data 108 provided by the client device 104 includes a set of data values that assess the project's quality metrics or performance metrics. These metrics is predefined parameters used to evaluate and measure the project's compliance with certain standards or goals. The secondary data 108 can include quantitative or qualitative measurements, indicating how well the project satisfies the defined metrics. In some cases, the secondary data 108 includes metrics that are provided in relation to the requirements-related concepts defined by the project fields 128. For example, the secondary data 108 includes quantitative or qualitative measurements that assess the extent to which the project satisfies or fulfills the requirements set forth by the project fields 128. For example, the secondary data includes a user-provided value representing the user's estimation of how much a requirement described by a success criterion has been met.

The reporting engine 116 utilizes the project schema 110 of a project to generate a comprehensive report about the project. By analyzing the data contained within the project schema 110, the reporting engine 116 determines relevant information, assesses progress, and generates insights that are consolidated into a detailed report. In some cases, to determine a report about the project, the reporting engine 116 examines various elements within the project schema 110. These elements includes project fields, secondary data, project stages, dependencies, and other pertinent information. By analyzing these components, the reporting engine 116 can provide an accurate representation of the project's status and performance. In some cases, the reporting engine 116 uses the project schema 110 to compile data and metrics related to the project's compliance with requirements, progress against predefined goals, and overall performance. In some cases, the reporting engine 116 processes the information within the project schema 110, applies any defined reporting criteria or formats, and generates a report that highlights key findings, milestones achieved, challenges encountered, and recommendations.

When a project is associated with a worksite 134, the reporting engine 116 can provide the generated report to a worksite planner device 120. The worksite planner device 120 enables a worksite planner to use the generated report to coordinate worksite activities. For example, in some cases, the worksite planner utilizes the report to gain insights into the project's status, progress, performance, compliance with requirements, achievement of milestones, and any identified risks or issues. By reviewing the report, the worksite planner can have a clear understanding of the project's current state and make informed decisions regarding worksite coordination. Based on the report, the worksite planner can assess the project's timelines, resource requirements, and potential impacts on worksite operations. This information helps in allocating resources effectively, scheduling tasks, and coordinating activities to ensure smooth and efficient worksite operations. The worksite planner can identify any dependencies, critical paths, or areas requiring special attention based on the insights provided in the report.

The worksite 134 includes one or more hardware devices such as one or more digging machines 140, one or more loading machines 136, one or more hauling machines 138, one or more transport machines (not shown), and/or other types of machines used for construction, mining, paving, excavation, and/or other operations at the worksite. Each of the machines described herein is in communication with each other and/or with a local or remote control system by way of one or more central stations 142. The central station may facilitate wireless communication between the machines described herein and/or between such machines and, for example, a system controller 144 of the control system, for the purpose of transmitting and/or receiving operational data and/or instructions.

Digging machines, including excavators, backhoes, dozers, drilling machines, trenchers, and draglines, is responsible for reducing materials at the worksite. Digging machines may perform tasks such as blasting, loading, hauling, and other operations to prepare materials for subsequent processes. Loading machines, such as wheeled or tracked loaders, front shovels, excavators, cable shovels, stack reclaimers, and similar machines, may lift, carry, load, and remove materials that have been reduced by the digging machines. Loading machines may transport materials within the worksite, often moving them from one location to another and loading them onto other machines or vehicles. Hauling machines, such as trucks, off-highway trucks, on-highway dump trucks, wheel tractor scrapers, and similar machines, is used for carrying excavated materials between different locations within the worksite. Hauling machines may transport overburden from excavation areas along haul roads to designated dump sites, and then return to the excavation areas for further loading.

In some cases, the system controller 144 modifies an operational parameter of at least one hardware device associated with the worksite 134 based on a recommended value provided by a project report. Ins some cases, the operational parameter of the hardware device comprises at least one of power consumption, processing speed, or cooling intensity. In some cases, the recommended value for the operational parameter of the hardware device is determined based on a comparison between a readiness value determined based on the current readiness level 130 and the relevance level 122 and a predetermined threshold. In some cases, the operational parameter includes one or more of: a project timeline, a resource allocation amount, a budget amount, a risk level, or a project complexity level. In some cases, the recommended value for the operational parameter of a hardware device is further determined based on historical data associated with the project schema 110.

Accordingly, as described, the assessment server device 102 enables maintaining project schemas 110, using the project schemas to determine cross-project similarities via the similarity engine 114, using the project schemas to determine cross-project dependencies via the dependency engine 112, and using the determines similarities and dependencies to generate a project report using the reporting engine 116. The report can then be used to modify operational parameters of devices operating in a worksite 134.

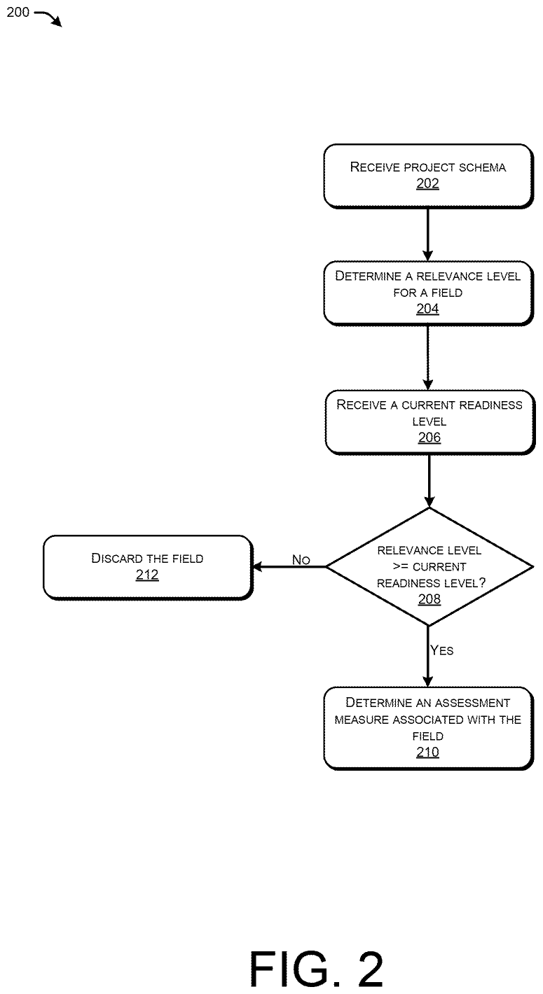

FIG. 2 is a flowchart diagram of an example process 200 for assessing a project with respect to a project field. As depicted in FIG. 2, at operation 202, the assessment server device 102 a project schema for the project. The project schema is a structured representation of the project's data, including project fields, secondary data, and other relevant information.

At operation 204, the assessment server device 102 determines a relevance level for a project field described by the received project schema. In some cases, the system processes the project field's metadata or designated values to identify the specific relevance level associated with the field. The relevance level represents the stage at which the project field becomes relevant and/or gets triggered.

At operation 206, the assessment server device 102 receives a current readiness level for the project. The current readiness level indicates the project's current state of progress, maturity, or technological advancement. The current readiness level can be determined based on predefined criteria, such as TRLs or other project-specific metrics.

At operation 208, the process 200 the assessment server device 102 determines whether the project field is applicable to the project. In some cases, the system determines whether the project field is applicable to the project based on whether the relevance level of the project field equals or exceeds the current readiness level of the project. The system may compare the relevance level obtained in operation 204 with the current readiness level received in operation 206. If the relevance level is equal to or greater than the current readiness level (operation 208—Yes), the assessment server device 102 determines that the project field is applicable to the project at its current stage. In some cases, the system determines that the project field is applicable to the project if: (i) the relevance level of the identified project field equals or exceeds the current readiness level of the project, and (ii) the maturity level of the project field exceeds a maturity level threshold. In some cases, the system determines that the project field is inapplicable to the project if: (i) the relevance level of the identified project field falls below the current readiness level of the project, or (ii) the maturity level of the project field does not exceed a maturity level threshold.

At operation 210, the assessment server device 102 determines an assessment measure for the project with respect to the requirements-related concept associated with the project field if the project field is determined to be applicable to the project (e.g., if relevance level of the project field is equal to or exceeds the current readiness level). In some cases, the assessment measure is a measure of how well the project satisfies the requirements-related concept (e.g., requirement and/or criterion) associated with the project field. For example, the assessment measure for a project's success criterion project field is determined by calculating customer satisfaction ratings, on-time delivery percentages, budget compliance variances, and/or the number of defects found during quality assurance testing.

If the system determines that the relevance level is less than the current readiness level (operation 208—No), at operation 212, the assessment server device 102 discards a requirements-related concept associated with the project field if the project field is determined to be inapplicable to the project (e.g., if relevance level of the project field falls below the current readiness level). In some cases, the system temporarily ignores the requirements-related concept associated with the project field because the project field is not yet applicable based on the project's current state and/or based on how well-defined the field is.

In some cases, the assessment measure is determined using values determined based on one or more process control techniques, such as at least one of the Six Sigma technique, the Statistical Process Control (SPC), or the Total Quality Management (TQM). Six Sigma aims to minimize defects and variations in a process by using statistical analysis and problem-solving methodologies. By incorporating the principles of Six Sigma, organizations can achieve higher levels of process efficiency, customer satisfaction, and overall quality. SPC involves monitoring and controlling a process using statistical tools and methods. It helps in identifying process variations, detecting abnormalities, and taking corrective actions to maintain the process within acceptable limits. SPC relies on statistical measures such as control charts, process capability analysis, and hypothesis testing to assess and control process performance. Furthermore, Total Quality Management (TQM) is a process control technique that focuses on continuous improvement and customer satisfaction. TQM involves various principles and practices, including customer-centricity, employee involvement, process optimization, and data-driven decision-making. By implementing TQM, organizations strive for excellence in all aspects of their operations, ensuring that customer needs are met, and the process is continually refined and enhanced.

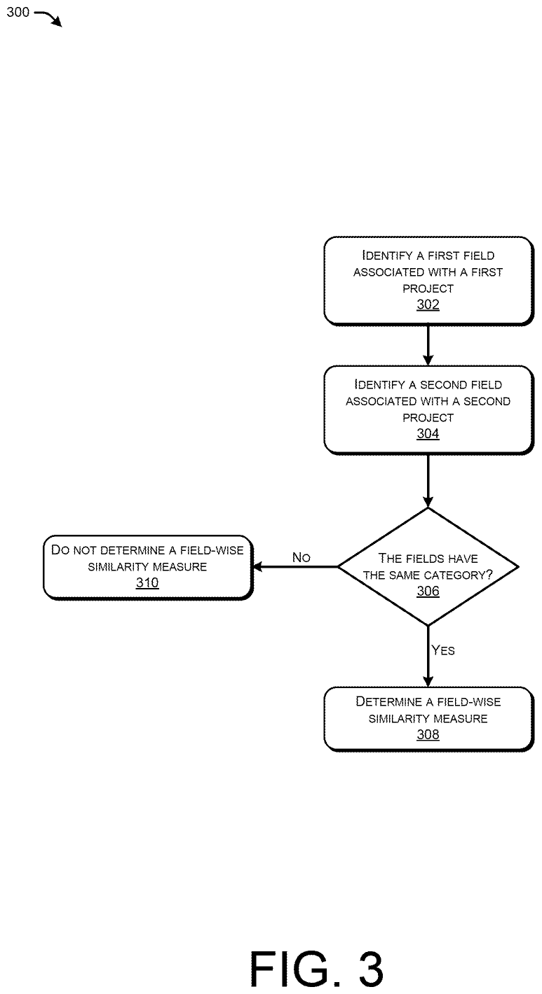

FIG. 3 is a flowchart diagram of an example process 300 for determining a field-wise similarity measure between a first field of a first project and a second field of a second project. As depicted in FIG. 3, at operation 302, the similarity engine 114 identifies (e.g., receives or determines) the first field of the first project. The first field is a project field of the first project. For example, the first field could be a success criterion project field associated with the first project. In some cases, the system retrieves description data associated with the first field.

At operation 304, the similarity engine 114 identifies the second field of the second project. The second field is a project field of the second project. For example, the second field could be a success criterion project field associated with the second project. In some cases, the system determines description data associated with the second field.

At operation 306, the similarity engine 114 determines whether the two fields have the same category. In some cases, the system determines whether the two fields belong to the same readiness category, such as success criteria, in-scope items, or preconditions. In some cases, if both the first and second fields share the same category, the system determines that the two fields can be compared in terms of similarity.

At operation 308, the similarity engine 114 determines a field-wise similarity measure for the two fields if the two fields have the same category (Operation 306—Yes). In some cases, the similarity engine 114 compares attributes of the first and second fields to quantify their similarity. For example, an NLP model can process textual descriptions associated with the fields and compute a similarity score based on semantic similarity and/or other linguistic analysis techniques. In some cases, the field-wise similarity measures for pairs of fields can be used to determine a project-wise similarity measure for the respective projects. By aggregating or combining the field-wise similarity measures across multiple fields within each project, the system can determine a project-wise similarity measure. This measure indicates the overall similarity between the two projects based on the similarities observed in their respective project fields.

At operation 310, the similarity engine 114 skips the determination of a field-wise similarity measure for the two fields if the two fields have the same category (Operation 306—No). In some cases, because association with two distinct categories indicates that the respective fields contain distinct subject matter and cannot be compared directly, the system does not compute a field-wise similarity determination for a pair of fields that have distinct categories.

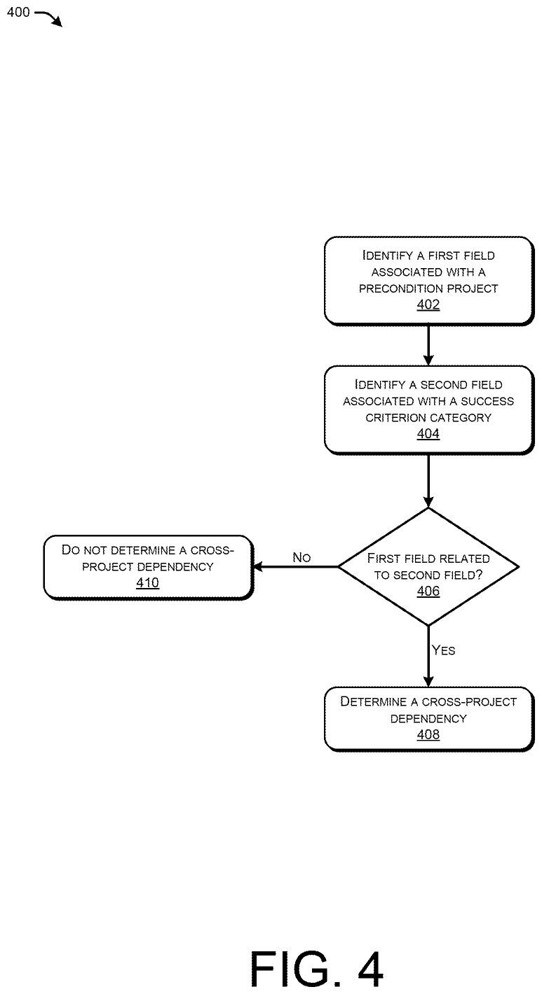

FIG. 4 is a flowchart diagram of an example process 400 for determining whether a first project is operationally dependent on a second project. As depicted in FIG. 4, at operation 402, the dependency engine 112 identifies a first field of the first project that is a precondition project field. In some cases, the system may query a specific project field within the project schema of the first project that is associated with a precondition readiness category. For example, the first field could be a project field indicating that a specific software module needs to be completed before the first project can progress.

At operation 404, the dependency engine 112 identifies a second field of the second project that is a success criterion project field. In some cases, the system may query a specific project field within the project schema of the project that is associated with a success criteria readiness category. For example, the second field could be a project field specifying the requirement that a specific software module needs to be completed as a result of the project.

At operation 406, the dependency engine 112 determines whether the first field is related to the second field. For example, the system determines that the first field is related to the second field if the description data for the second field includes a reference to (e.g., a field identifier of) the first field.

At operation 408, the dependency engine 112 determines that the first project is operationally dependent on the second field if the first field is related to the second field (Operation 406—Yes). In some cases, if the first field is related to the second field, the system determines that the fulfillment of the second project's success criterion project field is necessary for the successful progression of the first project. For example, if the first project's precondition project field references the second project's success criterion project field, it implies that the successful completion of the second project is a requirement before the first project can proceed.

For example, if a first project involves developing a software application, and a second project focuses on designing a user interface. The first project's precondition project field states that the user interface design must be completed before the software development can begin. Simultaneously, the second project's success criterion project field outlines the requirement of delivering a fully functional software application. In this case, the precondition project field of the first project is determined to be related to the success criterion project field of the second project. This indicates that the successful completion of the user interface design in the second project is crucial for the first project to proceed effectively.

At operation 410, the dependency engine 112 skips a determination that the first project is operationally dependent on the second field if the first field is related to the second field (Operation 406—No). In some cases, a first project is determined to be operationally dependent on a second project if at least one precondition project field of the first project is determined to be related to a success criterion project field of the second project.

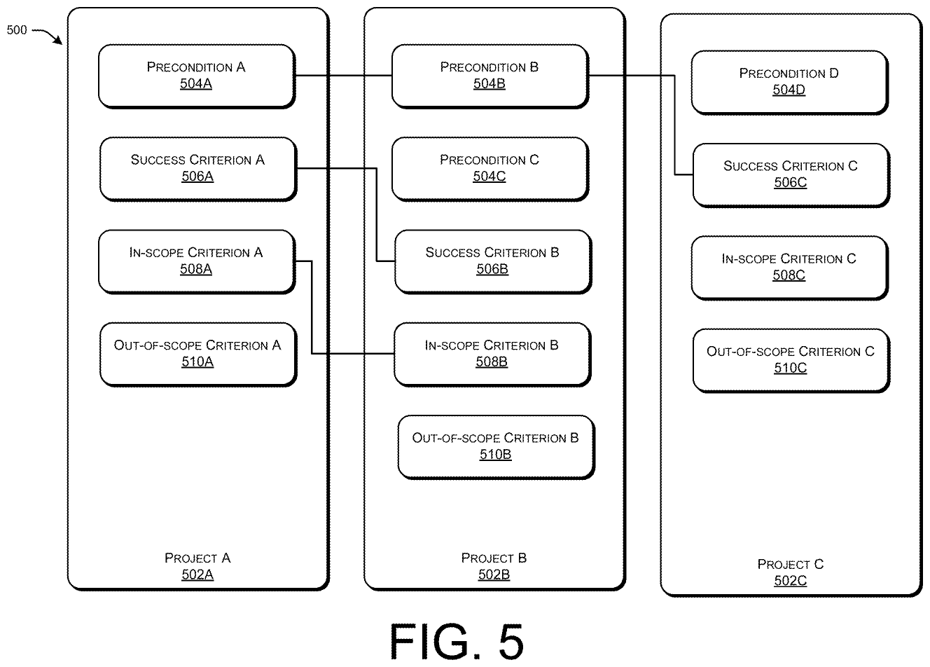

FIG. 5 is an operational example of an operational domain 500 with three projects. Project A 502A is associated with a precondition project field A 504A, a success criterion project field A 506A, an in-scope criterion project field A 508A, and an out-of-scope project field A 510A. Project B 502B is associated with a precondition project field B 504B that is related to the precondition project field A 504A, precondition project field C 504C, a success criterion project field B 506B that is determined to be related to the success criterion project field A 506A, an in-scope criterion project field B 508B that is related to the in-scope criterion project field A 508A, and an out-of-scope project field B 510B. Project C 502C is associated with a precondition project field D 504D, a success criterion project field C 506C that is related to the precondition project field B 504B, an in-scope criterion project field C 508C, and an out-of-scope project field C 510C.

A system can use the relationships between project fields of the operational domain 500 to determine that Project A 502A and Project B 502B are similar. To determine that Project A 502A and Project B 502B are similar, the system can analyze the relationships between their corresponding project fields. In this example, the precondition project field B 504B of Project B is related to the precondition project field A 504A of Project A. Additionally, the success criterion project field B 506B of Project B is determined to be related to the success criterion project field A 506A of Project A. These relationships indicate similarities in the requirements-related concepts between the two projects. By considering these related project fields having common readiness category, the system can determine that Project A and Project B are similar based on relationships between their common project fields.

Moreover, a system can use the relationships between project fields of the operational domain 500 to determine that Project C 502C is operationally dependent on Project B 502B. To determine that Project C 502C is operationally dependent on Project B 502B, the system can detect that precondition project field D 504D of Project C is related to the precondition project field B 504B of Project B. This relationship represents that the successful completion of the precondition project field B 504B in Project B is necessary for Project C to progress. Therefore, based on this relationship, the system can determine that Project C is operationally dependent on Project B.

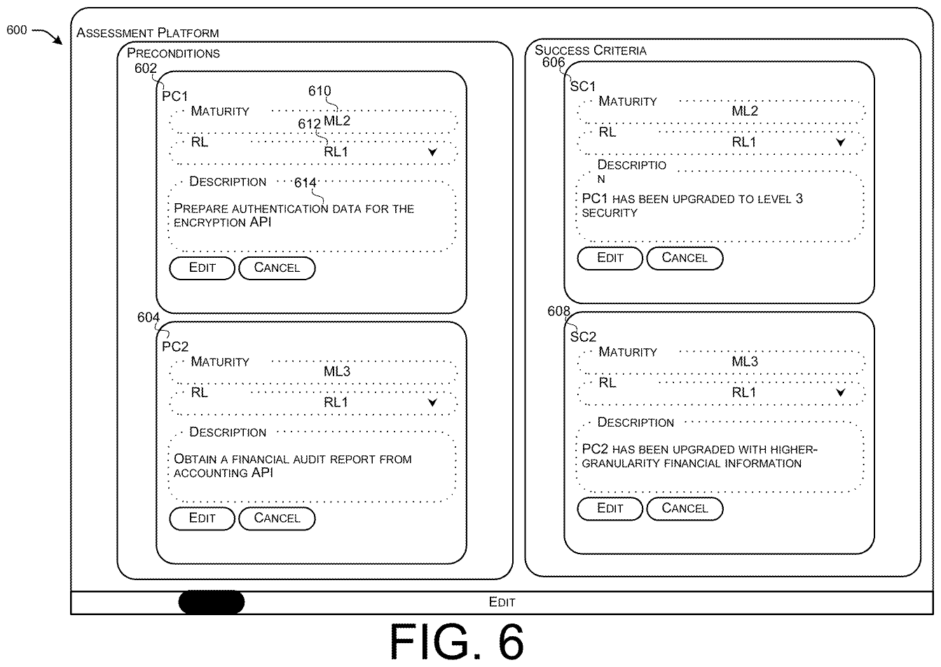

FIG. 6 provides an example assessment user interface 600 that allows a user to input information for a set of project fields. The assessment user interface 600 enables the user to provide the maturity level, relevance level, and description data for each project field. The depicted project fields in the interface include precondition project fields PC1 602 and PC2 604, as well as success criterion project fields SC1 606 and SC2 608. As shown in the figure, the user has filled in the maturity level 610, the relevance level 612, and the description data 614 for the PC1 602 project field.

The assessment user interface 600 of FIG. 6 may provide a structured and user-friendly platform for users to specify the characteristics and details associated with each project field. Users can input the maturity level, indicating the level of definition or clarity of the project field's requirements. The relevance level represents the stage or condition at which the project field becomes relevant or activated. Additionally, users can provide description data, which includes textual information or free-form text describing the specific requirements or concepts associated with each project field. By utilizing the assessment user interface 600, users can effectively capture and organize information related to the project fields, facilitating the assessment and evaluation of projects. Accordingly, the assessment user interface 600 streamlines the process of specifying the maturity level, relevance level, and description data for each project field, thus leading to consistency, accuracy, and ease of use in assessing projects against defined requirements.

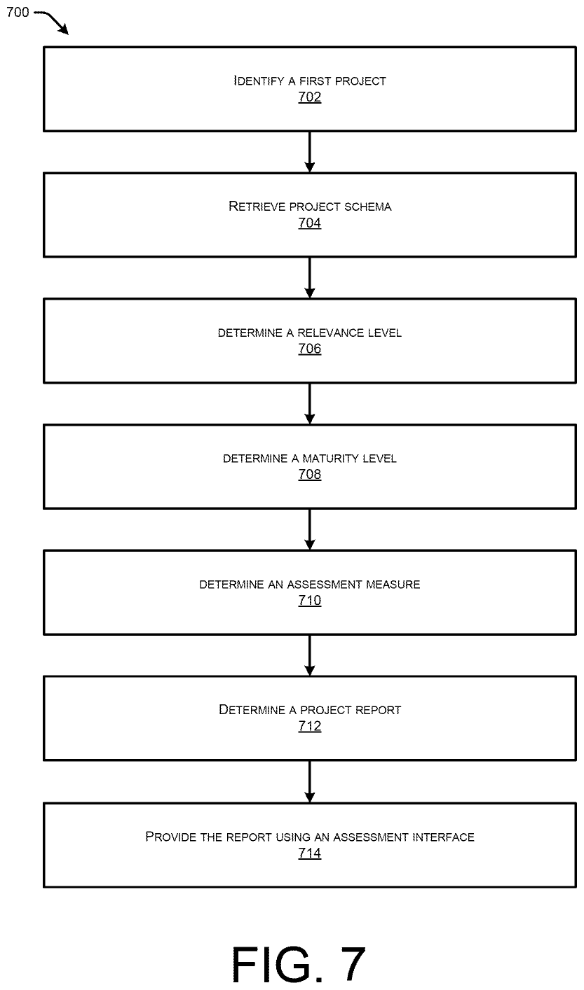

FIG. 7 is a flowchart diagram of an example process 700 for providing a project report for a first project. As depicted in FIG. 7, at operation 702, the assessment server device 102 identifies a first project. In some cases, identifying the first project includes retrieving a project identifier associated with the first project from a project database (e.g., from an active project database).

At operation 704, the assessment server device 102 retrieves the project schema for the first project. The project schema includes a structured representation of the first project's data, such as the project's project fields.

At operation 706, the assessment server device 102 determines a first relevance level for a first project field of the first project based on the project schema. The first relevance level represents the stage at which the first project field becomes most relevant or activated in the context of assessment of the first project. Determining the first relevance level includes querying the project schema to determine data describing stage at which the first project field becomes most relevant or activated

At operation 708, the assessment server device 102 determines a first maturity level for the first project field of the first project based on the project schema. The maturity level represents the extent to which a requirements-related concept of the first project field is well-defined by the description data associated with the first project field. Determining the first maturity level includes querying the project schema to determine data describing the level of maturity associated with the first project field.

At operation 710, the assessment server device 102 determines a first assessment measure for the first project field based on the first relevance level and the first maturity level. In some cases, the first assessment measure for the first project field based on: (i) a readiness value describing whether the first relevance level satisfies a triggering condition represented by the current readiness level of the first project, and (ii) a maturity value describing whether the first maturity level satisfies a maturity condition. The readiness value may be determined using a readiness determination subsystem, while the maturity value may be determined using a maturity determination subsystem.

In some cases, the maturity determination subsystem comprises a maturity rating routine that compares the maturity level with a predetermined maturity threshold to determine whether the maturity condition is satisfied. In some cases, the readiness determination subsystem comprises a comparison routine that compares the relevance level with the current readiness level to determine whether the triggering condition is satisfied. In some cases, the readiness determination subsystem includes a simulation routine that simulates various project scenarios to determine the readiness value.

The first assessment measure is determined based at least in part on whether the first relevance level satisfies a triggering condition represented by the current readiness level of the first project. This involves comparing the first relevance level, which signifies the stage at which the associated requirement becomes relevant, with the triggering condition based on the project's current readiness level. In some cases, if the first relevance level falls below the current readiness level and/or fails to satisfy the triggering condition, the first project is not evaluated with respect to the first project field. For example, consider a construction project where the first project field represents the completion of the architectural design phase. If the current readiness level of the project indicates that it is still in the initial planning stage, the triggering condition for the first project field may require the project to have reached the execution stage. In this case, as the first relevance level does not satisfy the triggering condition, the project is not evaluated with respect to the architectural design project field at that stage.

The first assessment measure is determined based at least in part on whether the first maturity level satisfies a maturity condition. The maturity condition is a threshold, and if the first maturity level falls below it, the project field is ignored or considered less significant in the assessment of the project. However, if the first maturity level meets or exceeds the maturity condition, it indicates a higher level of maturity, resulting in the project field being given greater weight in the overall assessment. This approach ensures that the evaluation process focuses on project fields that have reached an acceptable level of development while allowing for the flexibility to deprioritize fields that have not met the maturity threshold.

At operation 712, the assessment server device 102 determines a project report that includes the first assessment measure. In some cases, the report includes the assessment measure obtained for the first project field, along with any relevant analysis, findings, or recommendations. The project report can leverage visualizations to enhance understanding and communication of complex information. Visualizations, such as charts, graphs, and timelines, can be used to present project data, highlight key findings, depict resource allocation, and showcase risk assessments. The project report can include a visual representation of the first project schema, showcasing the first project field along with the corresponding first relevance level and first maturity level in a graphical format. This visualization can take the form of a diagram, chart, or other graphical representation. By visually presenting this information, stakeholders can easily comprehend the relationship between the project field and its associated levels, facilitating a clear understanding of the project's readiness status. This visual representation can enable quickly assessing the relevance and maturity of the project field, allowing stakeholders to gain insights into the project's overall progress and alignment with its requirements.

At operation 714, the assessment server device 102 provides the project report using an assessment interface. The assessment interface includes a user interface through which the project report is presented to a user.

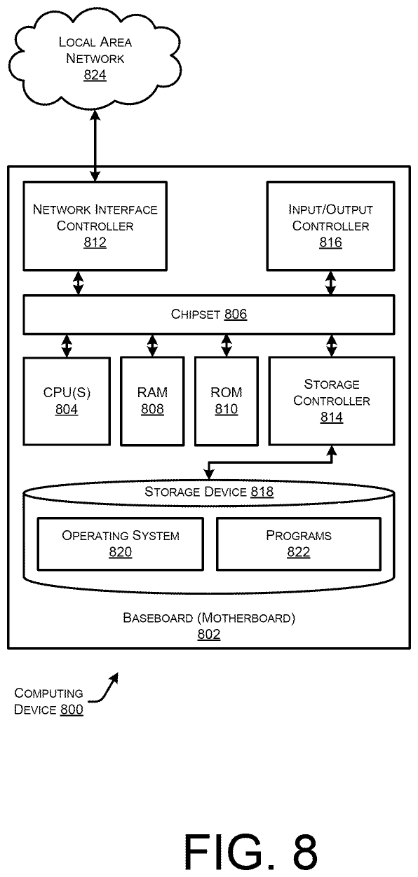

FIG. 8 shows an example system architecture for a computing device 800 associated with the environment 100 described herein. A computing device 800 can be a server, computer, or other type of computing device that executes at least a portion of the environment 100. In some examples, elements of the environment 100 can be distributed among, and/or be executed by, multiple computing devices 802. The computing device 800 may, for example, be the client device 104, the assessment server device 102, or the worksite planner device 120 of FIG. 1.

A computing device 800 can include memory 804. In various examples, the memory 804 can include system memory, which is volatile (such as RAM), non-volatile (such as ROM, flash memory, etc.) or some combination of the two. The memory 804 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media.

Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by one or more computing devices 802 associated with the environment 100. Any such non-transitory computer-readable media is part of the computing devices 802. The memory 804 can include modules and data 806 needed to perform operations of one or more computing devices 802 of the environment 100.

One or more computing devices 802 of the environment 100 can also have processor(s) 808, communication interfaces 810, displays 812, output devices 814, input devices 816, and/or a drive unit 818 including a machine readable medium 820.

In various examples, the processor(s) 808 can be a central processing unit (CPU), a graphics processing unit (GPU), both a CPU and a GPU, or any other type of processing unit. Each of the one or more processor(s) 808 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 808 may also be responsible for executing computer applications stored in the memory 804, which can be associated with common types of volatile (RAM) and/or nonvolatile (ROM) memory.

The communication interfaces 810 can include transceivers, modems, interfaces, antennas, telephone connections, and/or other components that can transmit and/or receive data over networks, telephone lines, or other connections.

The display 812 can be a liquid crystal display or any other type of display commonly used in computing devices. For example, a display 812 is a touch-sensitive display screen, and can then also act as an input device or keypad, such as for providing a soft-key keyboard, navigation buttons, or any other type of input.

The output devices 814 can include any sort of output devices known in the art, such as a display 812, speakers, a vibrating mechanism, and/or a tactile feedback mechanism. Output devices 814 can also include ports for one or more peripheral devices, such as headphones, peripheral speakers, and/or a peripheral display.

The input devices 816 can include any sort of input devices known in the art. For example, input devices 816 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 820 can store one or more sets of instructions, such as software or firmware, that embodies any one or more of the methodologies or functions described herein. The instructions can also reside, completely or at least partially, within the memory 804, processor(s) 808, and/or communication interface(s) 810 during execution thereof by the one or more computing devices 802 of the environment 100. The memory 804 and the processor(s) 808 also can constitute machine readable media 820.

### INDUSTRIAL APPLICABILITY

Aspects of the techniques described in this disclosure (e.g., with respect to the environment 100 of FIG. 1 or the processes provided in FIGS. 2-4) have significant applicability in numerous industrial sectors where project management and evaluation are critical. These sectors might include construction, manufacturing, software development, and any other sectors where the management of complex projects is a key component of operational success. The techniques provide a system that enables detailed assessment of project readiness and progress through the use of project schemas and specialized engines. By defining project fields such as preconditions, success criteria, and scope boundaries, techniques enable a structured and standardized representation of project-related information. This enhances data processing efficiency and facilitates easier comparison and computation, thus improving overall project management efficiency. Another key technical advantage of the techniques described in this disclosure relates to determining project dependencies, either through explicit user-defined relationships or inferred relationships. This capability enables better planning, risk mitigation, and resource allocation in complex multi-project environments. Furthermore, the automated decision-making capabilities, powered by the dependency engine, similarity engine, and reporting engine, can significantly streamline project evaluation and coordination efforts. By automatically generating project assessment reports, a proposed system can deliver valuable insights quickly and effectively, reducing the time and effort required by stakeholders for project evaluation or implementation. This has the potential to dramatically improve productivity and decision-making accuracy in numerous industrial settings.

For example, in a large-scale mining operation, efficient project management is essential for ensuring the smooth operation of various tasks such as exploration, extraction, loading, hauling, and transport of minerals. With complex project timelines and numerous dependencies between tasks, such a worksite could significantly benefit from the techniques described in the disclosure. A proposed system can be configured to assess the readiness and progress of different sub-projects within the mining operation. Each sub-project (e.g., site preparation, drilling, blasting, loading, hauling, and transportation) can be defined using project schemas with project fields like precondition, success criterion, and in-scope and out-of-scope fields. This structured representation of project-related information would enhance data processing efficiency, allowing for quicker and more accurate project assessments. Moreover, by utilizing the dependency engine, the system could determine dependencies between the different sub-projects. For example, loading cannot commence until blasting has been completed, and transportation cannot start until loading is done. This would allow the project managers to better plan and coordinate the tasks, reducing downtime and ensuring the smooth progression of operations.

Accordingly, the techniques described herein offer significant advantages in terms of improving project assessment efficiency, enhancing data processing and comparison, automating decision-making processes, and delivering valuable insights quickly. These capabilities make it an extremely valuable tool for any industry where effective project management and coordination are key to operational success.

Unless explicitly excluded, the use of the singular to describe a component, structure, or operation does not exclude the use of plural such components, structures, or operations or their equivalents. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated. While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A computer-implemented method, comprising:
retrieving a first project schema comprising a first project field associated with a first project;
determining a first relevance level indicated by the first project field, wherein the first relevance level represents a respective readiness level from a plurality of readiness levels at which a first requirement corresponding to the first relevance level is triggered;
determining a first maturity level associated with the first project field, wherein the first maturity level represents a measure of confidence in definitional maturity of the first requirement;
selecting a current readiness level from the plurality of readiness levels, wherein the current readiness level represents an estimated maturity of the first project;
determining a readiness value based on whether the first relevance level satisfies a triggering condition represented by the current readiness level;
determining a maturity value based on whether the first maturity level satisfies a maturity condition;
determining an assessment measure associated with the first project field based on the readiness value and the maturity value;
providing the assessment measure using an assessment platform; and
modifying an operational parameter of the first project schema based on the assessment measure.

2. The computer-implemented method of claim 1, further comprising:
determining a first field identifier associated with the first project field, wherein the first field identifier is unique across a plurality of field identifiers for a plurality of project fields associated with the first project.

3. The computer-implemented method of claim 2, further comprising:
receiving description data associated with a second project field in the plurality of project fields; and
determining that the description data comprises a reference to the first project field based on determining that the description data comprises the first field identifier.

4. The computer-implemented method of claim 1, further comprising:
retrieving a second project schema comprising a third project field associated with a second project; and
based on determining that a first field category associated with the first project field corresponds to a second field category associated with the third project field:
determining a field-wise similarity measure based on first description data associated with the first project field and third description data associated with the third project field; and
determining a project similarity measure associated with the first project and the second project based on the field-wise similarity measure.

5. The computer-implemented method of claim 4, wherein the first field category and the second field category are selected from a field category schema comprising an in-scope category, an out-of-scope category, a success criterion category, and a precondition criterion category.

6. The computer-implemented method of claim 4, further comprising:
determining the field-wise similarity measure by processing the first description data and the third description data using a natural language processing model.

7. The computer-implemented method of claim 1, further comprising:
retrieving a second project schema comprising a third project field associated with a second project; and
determining a dependency relationship between the first project and the second project based on: (i) determining that the third project field is associated with a precondition category and the first project field is associated with a success criterion category, and (ii) the assessment measure.

8. The computer-implemented method of claim 1, further comprising:
determining, based on the readiness value and the maturity value and using a first process control technique, a first measure;
determining a second measure using a second process control technique, and determining the assessment measure using the first measure and the second measure.

9. A computing system, comprising:
a processor; and
memory storing computer-executable instructions that, when executed by the processor, cause the computing system to perform operations comprising:
receiving, as an input of the computing system, a first project schema comprising a first project field associated with a first project, wherein:
the first project field is associated with a first relevance level,
the first relevance level represents a respective readiness level from a plurality of readiness levels at which a first requirement corresponding to the first relevance level is triggered;
the first project field is associated with a first maturity level, and
the first maturity level represents a measure of confidence in definitional maturity of the first requirement;
receiving a current readiness level from the plurality of readiness levels, wherein the current readiness level represents an estimated maturity of the first project;
providing the first project field and the current readiness level to a readiness determination subsystem;
receiving, from the readiness determination subsystem, a readiness value based on whether the first relevance level satisfies a triggering condition represented by the current readiness level;
providing the first project field to a maturity determination subsystem;
receiving, from the maturity determination subsystem, a maturity value based on whether the first maturity level satisfies a maturity condition;
determining, as an output of the computing system, a recommended value for an operational parameter of a project system associated with the first project schema based on the readiness value and the maturity value; and
transmitting the recommended value to the project system.

10. The computing system of claim 9, wherein the maturity determination subsystem comprises a maturity rating routine that compares the first maturity level with a predetermined maturity threshold to determine whether the maturity condition is satisfied.

11. The computing system of claim 9, wherein the readiness determination subsystem comprises a comparison routine that compares the first relevance level with the current readiness level to determine whether the triggering condition is satisfied.

12. The computing system of claim 9, wherein the operational parameter includes one or more of: a project timeline, a resource allocation amount, a budget amount, a risk level, or a project complexity level.

13. The computing system of claim 9, further comprising a project evaluation subsystem configured to receive the readiness value and the maturity value and apply a predefined formula to calculate the recommended value for the operational parameter.

14. The computing system of claim 9, wherein the first project schema is received from a user interface that enables a user to input project details and assign readiness and maturity levels to various requirements of the first project schema.

15. The computing system of claim 9, wherein the readiness determination subsystem and the maturity determination subsystem are implemented using machine learning models trained to predict the readiness value and the maturity value based on historical project data.

16. The computing system of claim 9, wherein the readiness determination subsystem includes a simulation routine that simulates various project scenarios to determine the readiness value.

17. One or more non-transitory computer-readable media storing computer-executable instructions that, when executed by a processor, cause the processor to perform operations, comprising:
transmitting a first project schema comprising a first project field associated with a first project to a computing system, wherein:
the first project field is associated with a first relevance level,
the first relevance level represents a respective readiness level from a plurality of readiness levels at which a first requirement corresponding to the first relevance level is triggered;
the first project field is associated with a first maturity level, and
the first maturity level represents a measure of confidence in definitional maturity of the first requirement;
transmitting a current readiness level from the plurality of readiness levels to the computing system, wherein the current readiness level represents an estimated maturity of the first project;
receiving, from the computing system, a recommended value for an operational parameter of a hardware device, wherein:
the computing system determines the recommended value based on a readiness value and a maturity value,
the readiness value is determined based on whether the first relevance level satisfies a triggering condition represented by the current readiness level, and
the maturity value based on whether the first maturity level satisfies a maturity condition; and
modifying the operational parameter of the hardware device based on the recommended value.

18. The one or more non-transitory computer-readable media of claim 17, wherein the recommended value for the operational parameter of the hardware device is determined based on a comparison between the readiness value and a predetermined threshold.

19. The one or more non-transitory computer-readable media of claim 17, wherein the recommended value for the operational parameter of the hardware device is further based on historical data associated with the first project schema.

20. The one or more non-transitory computer-readable media of claim 17, wherein the operational parameter of the hardware device comprises at least one of power consumption, processing speed, or cooling intensity.
